(19) United States
(12) Patent Application Publication
(10) Pub. No.: US 2003/0146005 A1
(43) Pub. Date: Aug. 7, 2003

(54) System and method for drawing fluid into a helicopter bucket

(75) Inventors: Peter Leighton Brooke, Ladysmith (CA); Robert Jefferson Thompson, Tsawwassen (CA)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Donald Brian Arney, Delta, BC (CA)

(21) Appl. No.: 10/071,965

(22) Filed: Feb. 6, 2002

(51) Int. Cl. A62C 25/00

(52) U.S. Cl. 169/53

(57) ABSTRACT

A helicopter fire fighting system including a fluid holding vessel suspended from underside of the helicopter; and submersible high volume, low head axial flow pump mounted adjacent bottom of the holding vessel for drawing fluid from a fluid source and delivering the fluid into the holding vessel, the axial flow pump extends along a central axis between an open upper end and an opposite open lower end serving as an inlet for the axial flow pump.

### BACKGROUND OF THE INVENTION

1. Field of Invention

This invention relates to a system and method for drawing fluid into a helicopter bucket, more particularly, for drawing fluid into a helicopter fire fighting bucket from a shallow fluid source

2. Description of Related Art

Helicopter fire fighting buckets are usually filled by dipping them into a body of water while suspended beneath a hovering helicopter. Various types of buckets are known. For example, commonly owned U.S. Pat. No. 5,829,809 to Arney, the disclosure of which is incorporated herein by reference, shows a collapsible bucket suspendable beneath a helicopter to deliver water to a fire. U.S. Pat. No. 5,560,429 to Needham discloses another example of a collapsible fire fighting bucket. Commonly owned U.S. Pat. No. 6,192,990 to Arney, the disclosure of which is incorporated herein by reference, discloses a bucket reservoir that may be either collapsible or rigid which includes a novel water release valve.

Generally, in order to fill the fire fighting bucket with water, the bucket must be completely submerged under water. In the case of a collapsible bucket, the bucket generally requires some upward velocity while underwater to fully expand the bucket. As such, a deep body of water is required to completely submerge a fire fighting bucket. A large bucket, for example, may require a body of water as deep as 15 feet.

In dry climates such as California and the Southern U.S. there are often no deep water sources. The only water source available in some places include shallow ponds, ditches or creeks. Thus, there is a need for a fire fighting bucket to retrieve water from a shallow water source.

Attempts have been made to satisfy the above need. For example, U.S. Pat. No. 6,209,593 to Nichols Sr. provides a pump system for a helicopter tanker including an axial flow electric pump coupled to a lower end of a snorkel extending from an onboard storage tank. The snorkel is dipped into the water source to draw the water into the onboard storage tank. The onboard storage tank is generally mounted against the underside of a helicopter via an expensive certified assembly. These two types of systems also require a long snorkel to reach down to the water surface while allowing the helicopter to maintain sufficient altitude for safety. A long snorkel, in turn, requires a powerful pump capable of pumping against a relatively high head in order to draw the water a long distance into the storage tank in a relatively short time to minimize hovering of the helicopter. It is known to use electric pumps to deliver water through the snorkel, but such pumps tend to be low volume and have a long fill time. Consequently, such systems require the helicopter to hover at a fixed altitude for a long period which is difficult for the pilot and hard on the helicopter. Alternatively, the snorkel system can use a certified pump that is heavy, very expensive and requires power to be drawn from the helicopter's main engine. This in turn, reduces the hovering ability and safety of the helicopter.

### SUMMARY OF THE INVENTION

Accordingly, there is a need for a low power and efficient way of drawing fluid into a helicopter fire fighting bucket from a shallow fluid source. The fire fighting bucket can be either a rigid or a collapsible container.

The present invention addresses the above needs by providing a helicopter system and method for drawing fluid into helicopter bucket by drawing fluid into a helicopter fire fighting bucket from a shallow fluid source.

In accordance with one aspect of the invention there is provided a helicopter bucket including a fluid holding vessel having a bottom suspended from the helicopter; and a submersible high volume, low head axial flow pump mounted adjacent the bottom of the holding vessel for drawing fluid from a fluid source and delivering the fluid into the holding vessel, the axial flow pump extends along a central axis between an open upper end and an opposite open lower end serving as an inlet for the axial flow pump.

The helicopter bucket may include means for releasing fluid from the vessel. The means for releasing fluid from the vessel may include a valve which has an inner assembly including a base plate spaced apart from a top plate, the base plate and the top plate defining therebetween an open side portion of the inner assembly, the base plate defining an outlet; and, an outer assembly including solid side walls, the outer assembly being movable with respect to the inner assembly between an open position and a closed position, an upper portion of the solid side walls being adapted to sealably cooperate with the top plate only when the outer assembly is in the closed position, a lower portion of the solid side walls being adapted to sealably cooperate with the base plate only when the outer assembly is in the closed position, wherein in the open position flow through the valve is permitted through the open side portion and the outlet of the outer assembly, and in the closed position flow through the valve is prevented by sealing engagement between the solid side walls of the outer assembly and the top plate and by engagement between the solid side walls and the base plate of the inner assembly.

The axial flow pump is powered by a power source. The power source may be the helicopter's electrical or hydraulic system, or may be a battery. The axial flow pump may be mounted inside of the bottom of the holding vessel, inside the valve, or may be mounted outside of the bottom of the holding vessel. The axial flow pump may also be moveable to a lowered position below the bottom of the holding vessel.

The axial flow pump may include a pump motor mounted adjacent the lower end of the axial flow pump; a water proof power cable connected to the pump motor and the power source, the power cable may be of sufficient length so that power may be delivered to the pump motor when the axial flow pump is in the lowered position; an output drive shaft extending from the motor along the central axis; an impeller mounted on the drive shaft for driven rotation therewith; a motor to pump adapter to provide a mount for the pump, to center the output drive shaft with the impeller and provide protection against water ingress along the output shaft; a recuperator for directing the flow of water through the axial flow pump, allowing the pump motor to pump at high volumes with lower power; a filter screen mounted adjacent the lower end of the axial flow pump to filter fluid as the fluid is drawn into the axial flow pump; and a flap valve mounted adjacent the upper end of the axial flow pump to provide the fluid with a unidirectional flow through the axial flow pump.

The helicopter bucket may further include a hose attached to the upper end of the axial flow pump and the inside of the holding vessel, the hose being of sufficient length so that fluid may be delivered into the holding vessel when the axial flow pump is in the lowered position.

The helicopter bucket may further include a protective guard attached adjacent the lower end of the axial flow pump to protect the axial flow pump from damage during operation.

The helicopter bucket may further include a load cell in communication with the axial flow pump for signaling the axial flow pump to automatically stop drawing fluid into the holding vessel when a predetermined amount of fluid has been drawn into the holding vessel. The load cell may alternatively be in communication with the helicopter for providing an operator of the helicopter a representation of an amount of fluid drawn into the holding vessel.

Additionally or alternatively, a level switch may be in communication with the helicopter for providing an operator of the helicopter a representation of an amount of fluid drawn into the holding vessel. The level switch may, alternatively, be in communication with the axial flow pump for signaling the axial flow pump to automatically stop drawing fluid into the holding vessel when a predetermined amount of fluid has been drawn into the holding vessel.

In accordance with another aspect of the invention there is provided a method for filling a helicopter bucket including suspending a fluid holding vessel, having a bottom, from the helicopter; and drawing fluid from a fluid source by using the submersible high volume, low head axial flow pump located adjacent the bottom of the holding vessel and delivering the fluid into the holding vessel.

The method may further include using power from the helicopter's electrical system to power the submersible high volume, low head axial flow pump. Alternatively, power from the helicopter's hydraulic system may be used to power the submersible high volume, low head axial flow pump. In a further alternative, a battery may be used to power the submersible high volume, low head axial flow pump.

The fluid may be drawn from inside the bottom of the holding vessel or may be drawn from outside the bottom of the holding vessel. The fluid may also be drawn from a lowered position below the bottom of the holding vessel. The method may further include delivering fluid to the holding vessel while drawing fluid from the lowered position.

The method may further include protecting the holding vessel against damage adjacent to where the fluid is being drawn.

The method may also include automatically stopping the drawing of fluid into the holding vessel when a predetermined amount of fluid has been drawn into the holding vessel or providing an operator of the helicopter a representation of an amount of fluid drawn into the holding vessel.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention,

FIG. 1 is an illustration of a preferred embodiment of the helicopter bucket attached to the underside of a helicopter with a break-away portion showing the inside of a holding vessel

FIG. 2 is an illustration of the helicopter bucket FIG. 1 which has been lowered into a pool of fluid

FIG. 3 is an illustration of an alternative embodiment of the helicopter bucket with a break-away portion depicting a flexible valve and pumps located underneath of the holding vessel

FIG. 4 is an illustration of an alternative embodiment of the helicopter bucket with a rigid holding vessel and a break-away portion depicting a butterfly valve

FIG. 5 is an illustration of an alternative embodiment of the helicopter bucket with a rigid holding vessel and a break-away portion depicting a flapper valve

FIG. 6 is an illustration of an alternative embodiment of the helicopter bucket with extendable pumps and a break-away portion showing the inside of a holding vessel

FIG. 7 is an exploded view of an embodiment of an axial pump

FIG. 8 is a cutaway perspective view of a holding vessel and an outer assembly and an embodiment of a valve and axial pump

### DETAILED DESCRIPTION

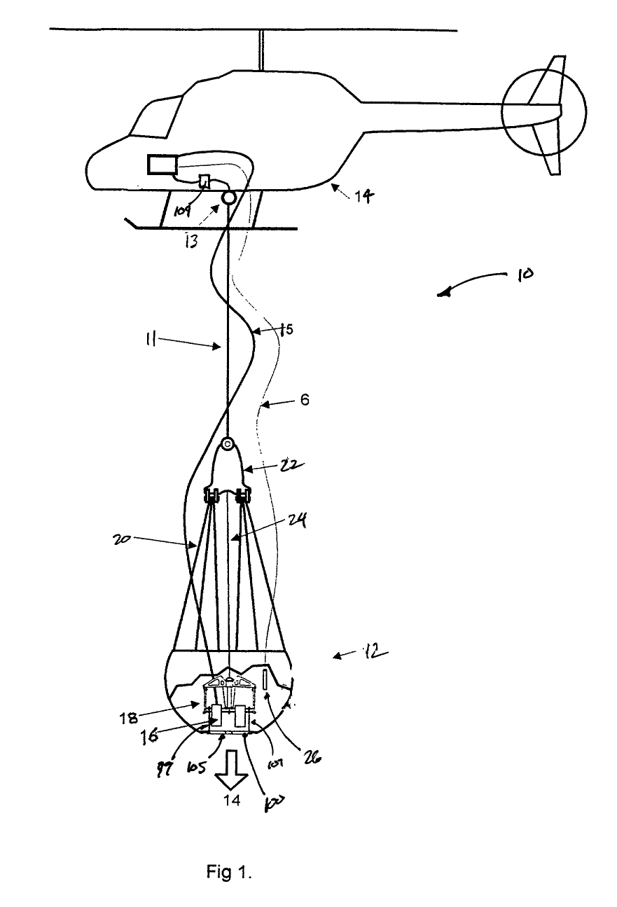

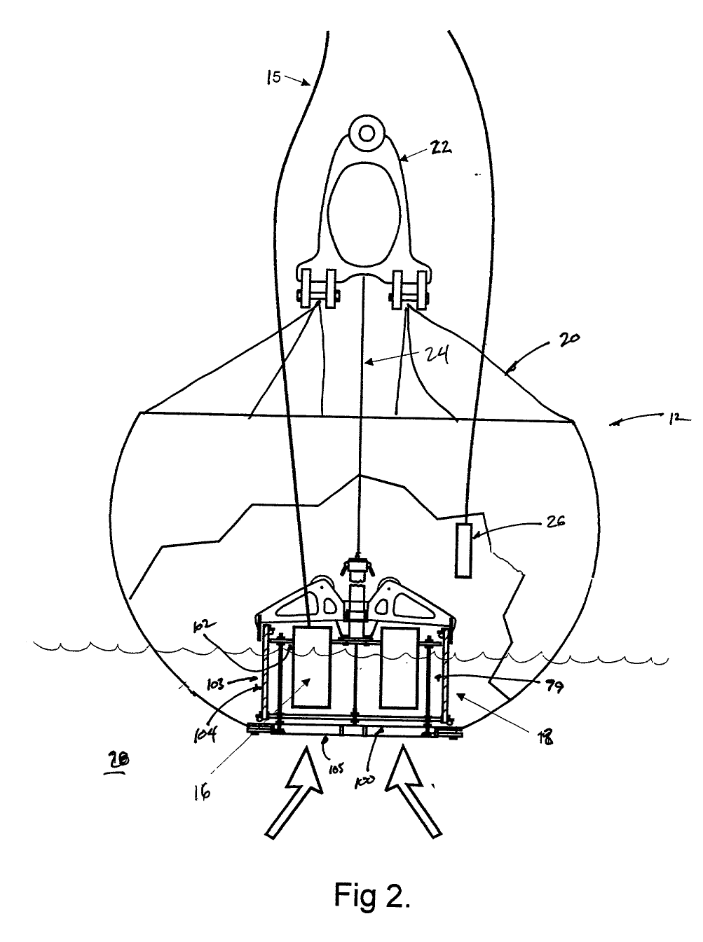

Referring to FIG. 1, a helicopter bucket according to a preferred embodiment of the invention is shown generally at 10. Apparatus 10 is suspended from a helicopter 14 via a suspension cable 11. Cable 11 attaches to a cargo hook 13 of helicopter 14. Apparatus 10 includes a fluid holding vessel 12 and a submersible high volume, low head axial flow pump 16 mounted adjacent the bottom of holding vessel 12. Holding vessel 12 illustrated in FIGS. 1 and 2 incorporates the patented valve described in commonly owned U.S. Pat. No. 6,192,990. The valve is essentially concerned with releasing water from the vessel while the present invention is directed to efficiently and reliably filling holding vessel 12.

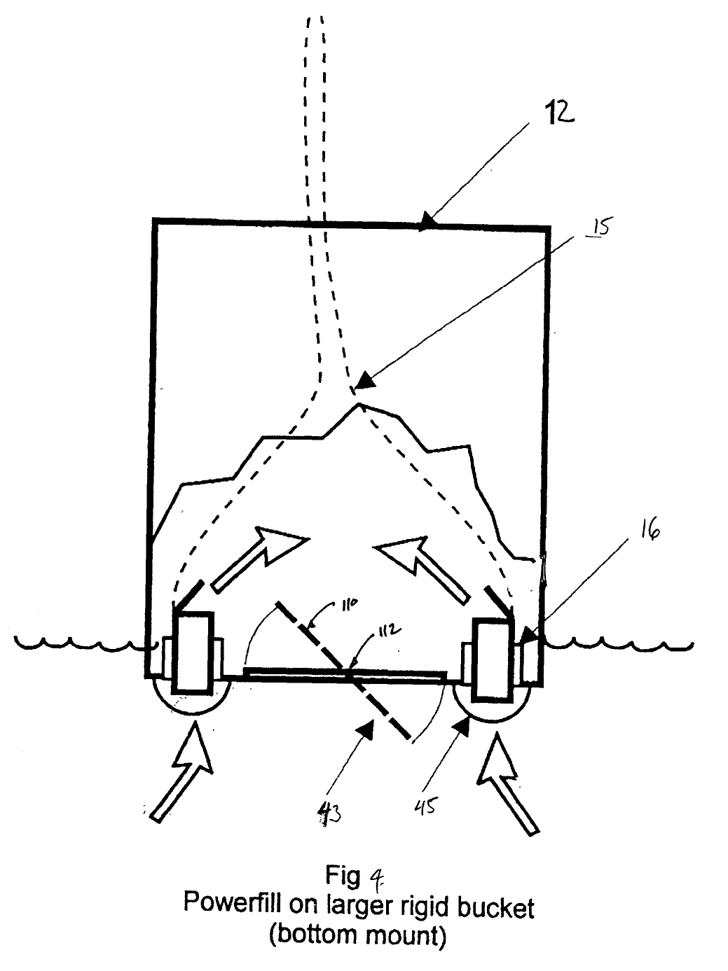

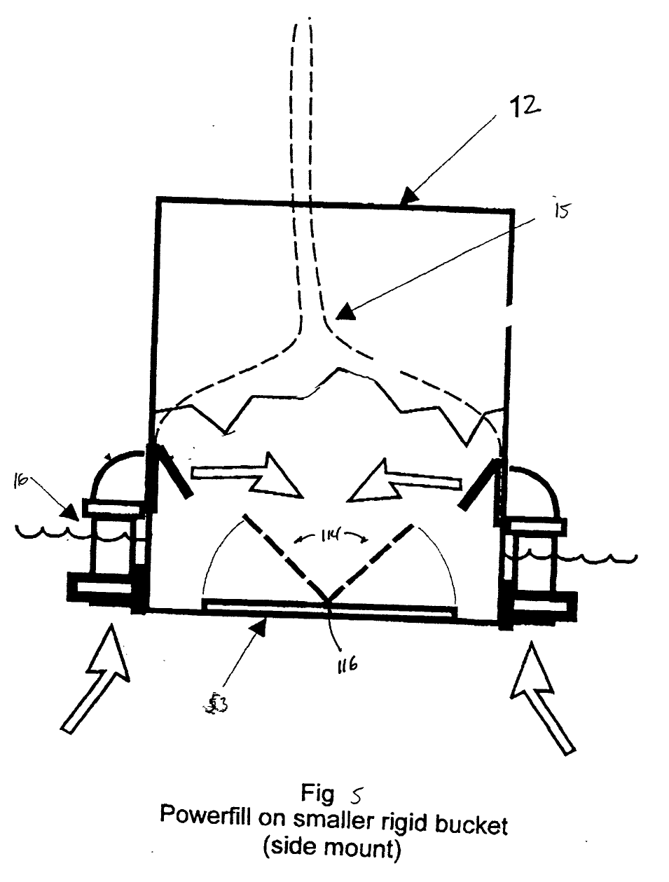

As illustrated in FIGS. 1, 2, 3 and 6, holding vessel 12 may be a collapsible bucket. However, as illustrated in FIGS. 4 and 5, holding vessel 12 may also be a rigid bucket.

Referring to FIGS. 1 and 2, axial flow pump 16 extends along a central axis between an open upper end and an opposite open lower end serving as an inlet for the pump. Axial flow pump 16 connects to a water proof power cable 15. Power for axial flow pump 16 may be provided by the helicopter's electrical system. For example, on small and medium sized helicopters axial flow pump 16 may be driven by a high efficiency permanent magnet DC motor (not shown) powered directly from the helicopter's nominal 28 volt electrical system. Alternatively, axial flow pump 16 may be powered by a battery pack located onboard the helicopter to render the pump independent of the helicopter's power system. On larger helicopters which have a more powerful AC electrical system, the motor may be an AC motor. In some cases, helicopters may already be fitted with onboard hydraulic systems for powering spreaders and seeders, for example. On such helicopters, axial flow pump 16 may be powered by the helicopter's hydraulic system.

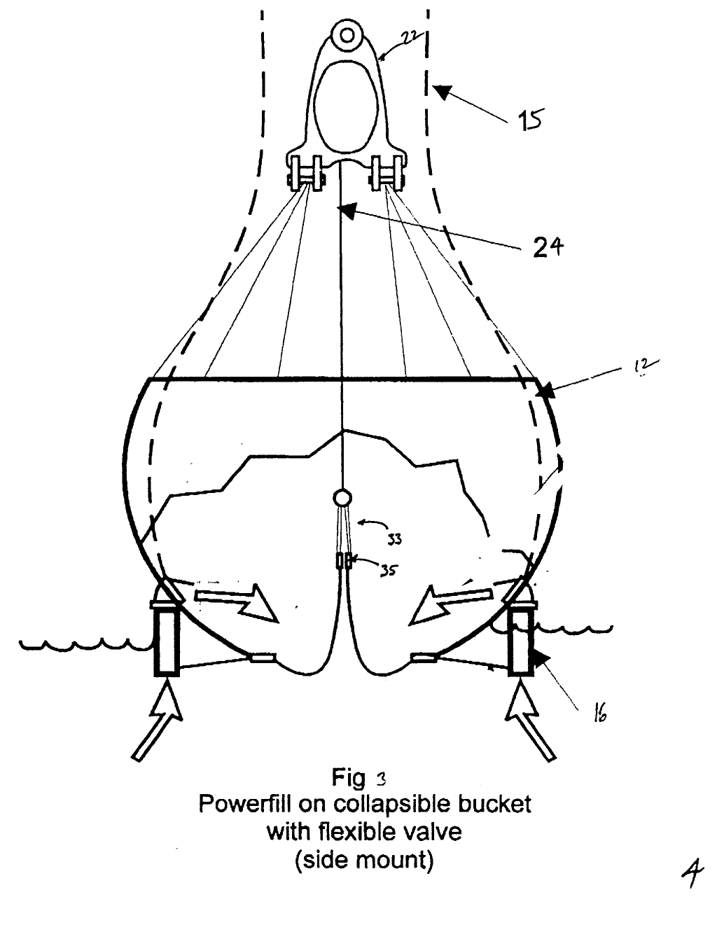

Apparatus 10 further includes means for releasing fluid from holding vessel 12. As those skilled in the art will appreciate, the means for releasing fluid from the vessel may include simply tilting holding vessel 12 or providing a closeable opening. In the present embodiment, the means for releasing fluid from holding vessel 12 includes a valve which may be a flexible valve 33 as illustrated in FIG. 3. In this embodiment, flexible valve 33 is controlled via operating cable 24. Valve 33 is shown generally in U.S. Pat. Nos. 4,474,245; 4,576,237; and 5,560,429. Valve 33 is held closed by a trip line (not shown) which holds the valve up against the water pressure in holding vessel 12 and uses purse strings (not shown) attached to the trip line to clamp the valve closed. When the trip line is released by control head 22, valve 33 inverts outwards through a hole 35 in the bottom of holding vessel 12, allowing the water to escape. When refilling holding vessel 12, the trip line is pulled in by control head 22 and latches. When the holding vessel 12 is lifted by a helicopter, the weight of water pressing down on valve 33 tightens the trip line and the purse strings and reseals the top of the valve. In an alternative embodiment the valve may be a butterfly valve 43 as illustrated in FIG. 4. In this embodiment, butterfly valve 43 includes a rocker plate 110 connected to holding vessel 12 via a pin 112. To open or close butterfly valve 43, an operator merely pivots rocker plate 110 about pin 112. In yet another embodiment, the valve may be a flapper valve 53 as illustrated in FIG. 5. In this embodiment, flapper valve 53 includes flap plates 114 connected to holding vessel 12 via a hinge pin 116. To open or close flapper valve 53, an operator merely pivots flap plates 114 about hinge pin 116. As those skilled in the art will appreciate, similar means for releasing fluid from the vessel may also be used. Preferably, the means for releasing fluid from the vessel is a multi-dump metering valve 18 as illustrated in FIGS. 1 and 2 and fully described in U.S. Pat. No. 6,192,990.

Referring to FIGS. 1 and 2, suspension lines 20 suspend holding vessel 12 from a control head 22. Operating cable 24 controls multi-dump metering valve 18 and attaches to control head 22.

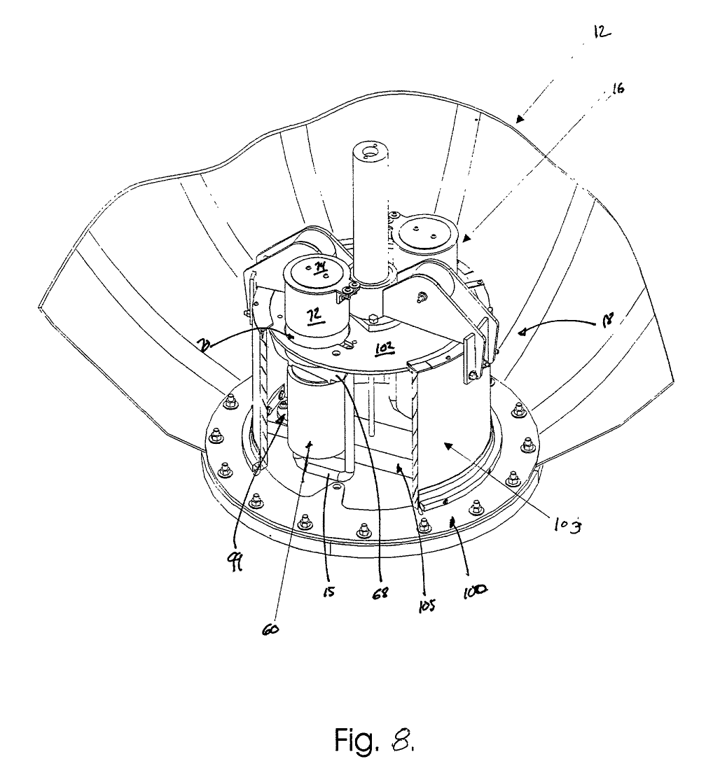

Referring to FIGS. 2 and 8, multi-dump metering valve 18 may include an inner assembly 99 including a base plate 100 spaced apart from a top plate 102. Base plate 100 defines an outlet 105. There is an outer assembly 103 which includes solid side walls 104. Outer assembly 103 is movable with respect to inner assembly 99 between an open position, as illustrated in FIG. 1, and a closed position, as illustrated in FIGS. 2 and 8. Referring to FIG. 1, in the open position, flow through the valve is permitted through open side portion 107 of inner assembly 99 and outlet 105 of base plate 100. Referring to FIGS. 2 and 8, in the closed position, flow through the valve is prevented by sealing engagement between solid side walls 104 of outer assembly 103 and top plate 102 and by sealing engagement between solid side walls 104 and base plate 100 of inner assembly 99.

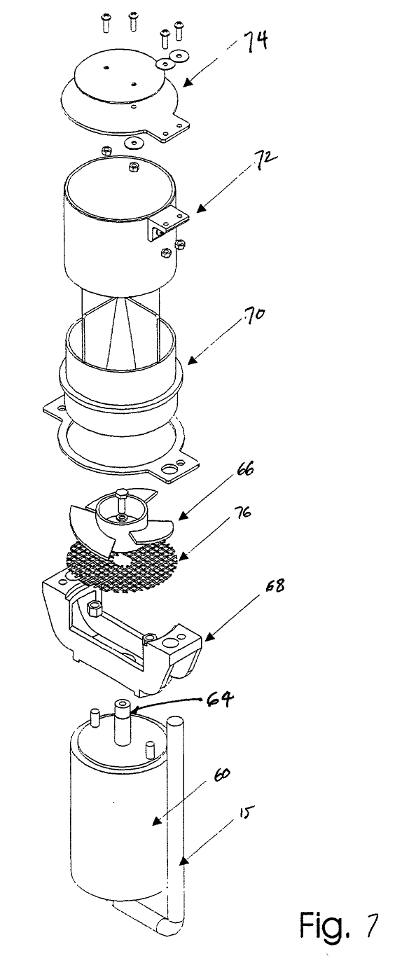

FIG. 7 illustrates an exploded view of a preferred embodiment of axial flow pump 16. In this embodiment, axial flow pump 16 includes a pump motor 60 mounted adjacent the lower end of axial flow pump 16. Water proof power cable 15 is connected to pump motor 60. An output drive shaft 64 extends from motor 60 to drive an impeller 66 for rotation therewith. A motor to pump adapter 68 is used to provide a mount for pump motor 60, to center output drive shaft 64 with impeller 66 and provide protection against water infiltration along output shaft 64. To provide protection against water infiltration along output shaft 64, adapter 68 incorporates a secondary self centering seal [not illustrated]. A cavity between the secondary self centering seal and the seal of pump motor 60 can be purged with grease through a nipple [not illustrated] in adapter 68. Axial flow pump 16 also includes a recuperator 70 for directing the flow of water through axial flow pump 16, allowing pump motor 60 to pump at high volumes with lower power. Fluid that is pumped into recuperator 70 exits via an exit duct 72. A flap valve 74 mounted adjacent the upper end of exit duct 72 ensures that the fluid flows through axial flow pump 16 in a unidirectional manner into holding vessel 12. A filter screen 76 is also provided to filter fluid as it is drawn into axial flow pump 16. In the illustrated embodiment, filter screen 76 is mounted adjacent impeller 66.

As illustrated in the preferred embodiment of FIG. 8, axial flow pump 16 is mounted inside of multi-dump metering valve 18. By placing axial flow pump 16 inside of multi-dump metering valve 18, valve 18 serves to protect axial flow pump 16 from damage when holding vessel 12 is lowered or swings into obstructions. In this embodiment, adapter 68 is connected to the underside of top plate 102 of multi-dump metering valve 18 to mount pump motor 60 below top plate 102. Impeller 66 along with filter 76 are placed within recuperator 70. Recuperator 70 is then placed through top plate 102, allowing exit duct 72 and flapper valve 74 to be positioned above top plate 102 to provide a path for fluid to enter holding vessel 12 while multi-dump metering valve 18 is in the closed position. FIG. 8 shows two axial flow pumps in operation, however, it will be appreciated by those skilled in the art that one or several axial flow pumps may be employed depending on a number of circumstances, including, the size of a holding vessel and the amount of fluid required to fill the holding vessel.

As illustrated in FIGS. 1, 2, and 4 axial flow pump 16 may be mounted inside of the bottom of holding vessel 12. However, depending upon an operator's needs, axial flow pump 16 may be mounted externally to the bottom of holding vessel 12 as illustrated in FIGS. 3 and 5. For example, since space is limited in small holding vessels, it may be necessary to mount axial flow pump 16 externally to the bottom of holding vessel 12 so that the interior of holding vessel 12 can be dedicated to holding fluid.

As best shown in FIG. 4, a protective guard 45 may be attached adjacent the lower end the axial flow pump 16 to protect the axial flow pump 16 from damage during operation.

Apparatus 10 may also have the ability to set the amount of fluid in holding vessel 12 and hence the overall load helicopter 14 has to lift. This feature is very important at higher altitudes or in very hot conditions when helicopter 14 cannot pickup its full rated load. Referring to FIG. 1, apparatus 10 may include a load cell 109, attached to cargo hook 13, in communication with axial flow pump 16. Load cell 109 may signal axial flow pump 16 to automatically stop drawing fluid into holding vessel 12 when a predetermined amount of fluid has been drawn into holding vessel 12. Alternatively, load cell 109 may provide an operator of helicopter 14 a representation of an amount of fluid drawn into holding vessel 12. The operator can then determine whether to stop axial flow pump 16 from further drawing fluid into holding vessel 12. In an alternative embodiment, as best shown in FIG. 2, a level switch 26 may be in communication with axial flow pump 16. Level switch 26 may signal axial flow pump 16 to automatically stop drawing fluid into holding vessel 12 when a predetermined amount of fluid has been drawn into holding vessel 12. Alternatively, level switch 26 may provide an operator of helicopter 14 a representation of an amount of fluid drawn into holding vessel 12. The operator can then determine whether to stop axial flow pump 16 from further drawing fluid into holding vessel 12.

Operation

Referring to FIG. 2, apparatus 10 is lowered into a pool of fluid 28 to allow axial flow pump 16 to draw fluid into holding vessel 12. Because axial flow pump 16 is adjacent the bottom of holding vessel 12, axial flow pump 16 has a short vertical distance to move the fluid into holding vessel 12. This greatly reduces the power required to draw the fluid as compared to conventional systems, for example, long snorkel and belly tank systems as mentioned above.

Referring to FIGS. 2 and 8, in the preferred embodiment, outer assembly 103 is initially in the closed position. In order to draw the fluid into holding vessel 12, apparatus 10 should be lowered so that impeller 66 is submersed within the fluid. Outlet 105 allows the fluid to enter multi-dump metering valve 18 so that the fluid can then be drawn through recuperator 70 to exit via exit duct 72 into holding vessel 12. Since outer assembly 103 is in the closed position, the fluid is maintained within holding vessel 12. Referring to FIG. 1, to release the fluid, the operator actuates operating cable 24 to raise outer assembly 103 into the open position, allowing the fluid to pass through open side portion 107 of inner assembly 99 and outlet 105 of base plate 100.

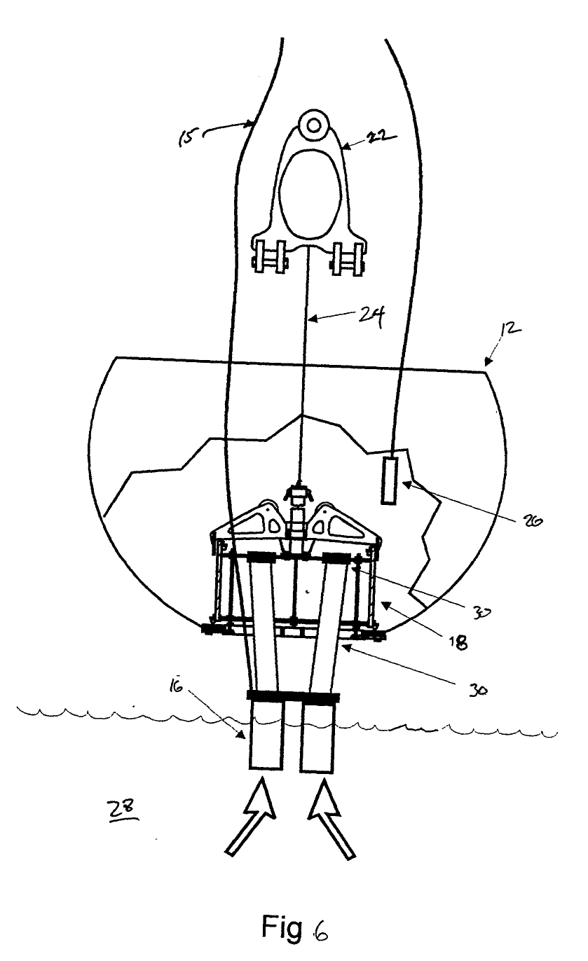

Should apparatus 10 be required to operate in an area with a very shallow or small fluid source, for example in irrigation ditches running between fields or roadside ditches in rural areas, axial flow pump 16 may be moveable to a lowered position below the bottom of holding vessel 12, as best shown in FIG. 6. In the preferred embodiment, axial flow pump 16 may be connected to multi-dump metering valve 18 via a Kam Lock type clamp for easy removal of axial flow pump 16 from multi-dump metering valve 18. The Kam Lock type clamp is manually operated to release axial flow pump 16 from holding vessel 12 before takeoff of helicopter 14. Additionally, apparatus 10 may further include a hose 30 attached to the upper end of axial flow pump 16 and the inside of holding vessel 12. Hose 30 is of sufficient length so that fluid may be delivered into holding vessel 12 when axial flow pump 16 is in the lowered position. In this embodiment, because holding vessel 12 is suspended from helicopter 14 after takeoff, holding vessel 12 is close to the fluid source. As such, a short hose for example, 2 feet in length, may be used. Using such a short hose overcomes the disadvantages associated with aforementioned snorkel arrangements, which require long snorkels to fill an onboard storage tank. Additionally, in this embodiment, waterproof power cable 15 may be of sufficient length so that power may be delivered to pump motor 60 when axial flow pump 16 is in the lowered position.

While specific embodiments of the invention have been described and illustrated, such embodiments should be considered illustrative of the invention only and not as limiting the invention as construed in accordance with the accompanying claims.

What is claimed is:

1. A helicopter bucket comprising:
a fluid holding vessel, having a bottom, suspended from the helicopter; and
a submersible high volume, low head axial flow pump mounted adjacent the bottom of the holding vessel for drawing fluid from a fluid source and delivering the fluid into the holding vessel, the axial flow pump extends along a central axis between an open upper end and an opposite open lower end serving as an inlet for the axial flow pump.

2. The helicopter bucket of claim 1 further comprising a means for releasing fluid from the vessel.

3. The helicopter bucket of claim 2 wherein the means for releasing fluid from the vessel comprises a valve.

4. The helicopter bucket of claim 3 wherein the valve comprises an inner assembly, the inner assembly comprising a base plate spaced apart from a top plate, the base plate and the top plate defining therebetween an open side portion of the inner assembly, the base plate defining an outlet; and, an outer assembly comprising solid side walls, the outer assembly being movable with respect to the inner assembly between an open position and a closed position, an upper portion of the solid side walls being adapted to sealably cooperate with the top plate only when the outer assembly is in the closed position, a lower portion of the solid side walls being adapted to sealably cooperate with the base plate only when the outer assembly is in the closed position, wherein in the open position flow through the valve is permitted through the open side portion and the outlet of the outer assembly, and in the closed position flow through the valve is prevented by sealing engagement between the solid side walls of the outer assembly and the top plate and by engagement between the solid side walls and the base plate of the inner assembly.

5. The helicopter bucket of claim 1 wherein the axial flow pump is powered by a power source.

6. The helicopter bucket of claim 5 wherein the power source is the helicopter's electrical system.

7. The helicopter bucket of claim 5 wherein the power source is the helicopter's hydraulic system.

8. The helicopter bucket of claim 5 wherein the power source is a battery.

9. The helicopter bucket of claim 1 wherein the axial flow pump is mounted inside of the bottom of the holding vessel.

10. The helicopter bucket of claim 3 wherein the axial flow pump is mounted inside of the valve.

11. The helicopter bucket of claim 1 wherein the axial flow pump is mounted outside of the bottom of the holding vessel.

12. The helicopter bucket of claim 3 wherein the axial flow pump is moveable to a lowered position below the bottom of the holding vessel.

13. The helicopter bucket of claim 12 further comprising a hose attached to the upper end of the axial flow pump and the inside of the holding vessel, the hose being of sufficient length so that fluid may be delivered into the holding vessel when the axial flow pump is in the lowered position.

14. The helicopter bucket of claim 1 wherein the axial flow pump comprises:
a pump motor mounted adjacent the lower end of the axial flow pump;
a water proof power cable connected to the pump motor and a power source;
an output drive shaft extending from the motor along the central axis;
an impeller mounted on the drive shaft for driven rotation therewith;
a motor to pump adapter to provide a mount for the pump, to center the output drive shaft with the impeller and provide protection against water ingress along the output shaft;
a recuperator for directing the flow of water through the axial flow pump, allowing the pump motor to pump at high volumes with lower power;
a filter screen mounted adjacent the lower end of the axial flow pump to filter fluid as the fluid is drawn into the axial flow pump;
an exit duct mounted adjacent the recuperator to allow fluid to exit from the recuperator; and
a flap valve mounted adjacent upper end of the exit duct to ensure that the fluid flows through the axial flow pump in a unidirectional manner.

15. The helicopter bucket of claim 14, wherein the power cable is of sufficient length so that power may be delivered to the pump motor when the axial flow pump is in a lowered position.

16. The helicopter bucket of claim 1 further comprising a protective guard attached adjacent the lower end of the axial pump to protect the axial pump from damage during operation.

17. The helicopter bucket of claim 1 further comprising a load cell in communication with the axial flow pump for signaling the axial flow pump to automatically stop drawing fluid into the holding vessel when a predetermined amount of fluid has been drawn into the holding vessel.

18. The helicopter bucket of claim 1 further comprising a load cell in communication with the helicopter for providing an operator of the helicopter a representation of an amount of fluid drawn into the holding vessel.

19. The helicopter bucket of claim 1 further comprising a level switch in communication with the axial flow pump for signaling the axial flow pump to automatically stop drawing fluid into the holding vessel when a predetermined amount of fluid has been drawn into the holding vessel.

20. The helicopter bucket of claim 1 further comprising a level switch in communication with the helicopter for providing an operator of the helicopter a representation of an amount of fluid drawn into the holding vessel.

21. A method for filling a helicopter bucket comprising:
suspending a fluid holding vessel, having a bottom, from the helicopter; and
drawing fluid from a fluid source by using a submersible high volume, low head axial flow pump located adjacent the bottom of the holding vessel and delivering the fluid into the holding vessel.

22. The method of claim 21 further comprising using power from the helicopter's electrical system to power the submersible high volume, low head axial flow pump.

23. The method of claim 21 further comprising using power from the helicopter's hydraulic system to power the submersible high volume, low head axial flow pump.

24. The method of claim 21 further comprising using power from a battery to power the submersible high volume, low head axial flow pump.

25. The method of claim 21 wherein the fluid is drawn from inside of the bottom of the holding vessel.

26. The method of claim 21 wherein the fluid is drawn from outside of the bottom of the holding vessel.

27. The method of claim 21 wherein the fluid is drawn from a lowered position below the bottom of the holding vessel.

28. The method of claim 27 further comprising delivering fluid to the holding vessel while drawing fluid from the lowered position.

29. The method of claim 21 further comprising protecting the holding vessel against damage adjacent to where the fluid is being drawn.

30. The method of claim 21 further comprising automatically stopping the drawing of fluid into the holding vessel when a predetermined amount of fluid has been drawn into the holding vessel.

31. The method of claim 21 further comprising providing an operator of the helicopter a representation of an amount of fluid drawn into the holding vessel.
